(19) United States
(12) Patent Application Publication
(10) Pub. No.: US 2002/0119891 A1
(43) Pub. Date: Aug. 29, 2002

(54) Integrated methods for control of aquatic weeds

(76) Inventor: Michael D. Netherland, Carmel, IN (US)

Correspondence Address: Woodard, Emhardt, Naughton,, Moriarty and McNett, Bank One Center/Tower, 111 Monument Circle, Suite 3700, Indianapolis, IN, 46204-5137, US

(21) Appl. No.: 09/946,073

(22) Filed: Sep. 4, 2001

Related U.S. Application Data
(63) Continuation of application No. 09/766,105, filed on Jan. 19, 2001.

(51) Int. Cl. A01N 43/34

(52) U.S. Cl. 504/155

(57) ABSTRACT

Described are preferred methods for the control of aquatic weed populations using the bleaching herbicide fluridone and advantageously incorporating assessments of fluridone susceptibility of the local population before and during treatment along with measured levels of fluridone in the water body. Integrated weed management in accordance with invention facilitates the achievement of effective control even where there is a large intra-species variation in susceptibility to fluridone among different, localized populations of the species. Also described are methods for assessing weeds for susceptibility to a herbicidal agent involving incubating weed tissue samples in a growth medium effective to initiate new growth, contacting the samples with the agent, and analyzing the impact of the agent contact on new tissue growth.

### BACKGROUND

The present invention relates generally to the control of aquatic weeds, and in particular to an integrated method for the control of aquatic weeds using fluridone.

As further background, various methods exist for the control of aquatic weeds. The selection of an appropriate control method depends upon many factors such as environmental impact, cost effectiveness, efficacy, and the like. The various control methods available include physical controls such as mechanical harvesting, hand pulling or cutting, or the use of bottom barriers or water level draw-down. These methods can be both time consuming and labor intensive, and can create significant environmental disturbance, especially when considered on a large scale. Other mechanical controls such as rotovation have similar drawbacks.

Biological controls such as the use of triploid grass carp can be desirable in some aquatic systems in that they reduce the use of equipment and have the potential for long term control of aquatic weeds. Nonetheless, in many aquatic systems, triploid grass carp often completely remove all aquatic vegetation for many years. The long-term environmental impacts result in reluctance of many natural resource managers to use triploid grass carp for these purposes. In temperate aquatic systems, the efficacy of such biological controls can also vary widely, and is dependent upon factors such as feeding preferences, metabolism, temperature, and stocking rate.

For these and other related reasons, the use of aquatic herbicides has become a common method for controlling invasive aquatic weeds. The use of herbicidal control nonetheless also presents risks and difficulties including the potential impact on the local environment, the potential for excessive decrease in the dissolved oxygen (DO) content of the waters due to rapid plant decay, and the potential for differential herbicide-tolerance to develop.

In light of this background, there is a need for improved methods for the control of aquatic weeds with chemical herbicides such as fluridone. Such methods would desirably assist in minimizing environmental impacts of the treatment while facilitating successful control of the target weed or weeds through the ability to identify the potential susceptibility of various weed populations. The ability to maintain lethal threshold concentrations will facilitate preventing situations in which insufficient amounts of fluridone are applied resulting in treatment failure as well as increasing the chances of the plant becoming more tolerant. Likewise, these methods will provide information which discourages overdosing a system. Significant overdosing can result in greater non-target impacts, and can reduce cost-effictiveness of treatments. Cost effectiveness is an important issue as much of the funding for aquatic plant control activities is derived from county, state and federal tax dollars. The present invention addresses these needs.

### SUMMARY OF THE INVENTION

It has been discovered that local populations of aquatic weeds of the same species have significantly differing susceptibility to the herbicide fluridone, and that effective control of such weeds can be achieved utilizing an integrated aquatic weed control method which takes into account assessments of fluridone levels and assessments of the efficacy of the fluridone level on the aquatic weeds before and during the treatment program. Accordingly, the present invention provides in one preferred embodiment an integrated method for the control of aquatic weeds in a body of water. The inventive method includes maintaining fluridone in a body of water having aquatic weeds. Water samples from the body of water are assessed to determine the level of fluridone in the water. As well, aquatic weed samples from the body of water are assessed to determine the effect of the fluridone on the weeds. From the results of such assessments, a determination is made whether to adjust the level of fluridone in the body of water, whereby a phytotoxic level of fluridone against the local population of aquatic weeds can be maintained.

Another embodiment of the invention provides a method for assessing the effect of fluridone on an aquatic weed population. The method comprises the step of obtaining samples of aquatic weeds from a body of water under treatment with fluridone. These samples are then assessed to determine the efficacy of the existing level of fluridone in controlling the aquatic weeds. This determination can then be used in weed management decisions such as whether to adjust the level of fluridone maintained in the body of water.

A further preferred embodiment of the present invention provides a method for assessing the effect of fluridone on an aquatic weed population prior to field treatment of the population with fluridone. The method comprises the step of obtaining samples of aquatic weeds from a body of water prior to treatment with fluridone. These samples are then assessed to determine the efficacy of varying levels of fluridone for controlling the target aquatic weeds. This determination can then be used in arriving at a treatment level of fluridone to be applied to the body of water, and the body of water can then be treated with fluridone.

Another preferred embodiment of the invention provides a method for assessing the susceptibility of a local aquatic weed population to a chemical agent. The method comprises obtaining a plurality of aquatic weed tissue samples from aquatic weeds from a body of water, wherein the aquatic weed tissue samples are effective to initiate new tissue growth. The tissue samples are incubated in a growth medium effective to support new tissue growth. During incubation, the tissue samples are subjected to varying levels of the chemical agent, wherein new tissue growth from the samples after the incubation period can be assessed to determine a susceptibility of the aquatic weed population to the chemical agent. Illustratively, the new growth tissue can be isolated and assayed as to levels of biological substances that are correlated to the effect of the agent. For example, in the case of bleaching herbicidal agents, the new growth tissue can be assayed for levels of one or more pigments or other biological substances correlated to the effect of the bleaching agent. Advantageous methods can be conducted as small-scale, laboratory assays, thus avoiding the need to grow and assess entire plants.

The present invention provides improved methods for the control of aquatic weeds using herbicides such as fluridone. The present invention also provides assays that can be used in such control methods. These and additional embodiments and advantages of the invention will be apparent from the descriptions herein.

### DESCRIPTION OF THE PREFERRED EMBODIMENTS

For the purposes of promoting an understanding of the principles of the invention, reference will now be made to certain embodiments thereof and specific language will be used to describe the same. It will nevertheless be understood that no limitation of the scope of the invention is thereby intended, such alterations, further modifications and further applications of the principles of the invention as described herein being contemplated as would normally occur to one skilled in the art to which the invention relates.

As disclosed above, the present invention provides integrated methods for the control of aquatic weeds which involve maintaining a level of fluridone in a body of water having the aquatic weeds, and assessing water samples and weed samples from the body of water to determine the level of fluridone in the water and the effect of the fluridone on the weeds. From these assessments a determination is made whether to adjust the level of fluridone in the body of water, and if necessary the level of fluridone is adjusted. In this manner, a phytotoxic level of fluridone may be maintained in the water even in the face of large intra-species variation in susceptibility to fluridone.

The chemical fluridone, formally named 1-methyl-3phenyl-5-3-(trifluoromethyl)phenyl-4(1H)-pyridinone, is a known herbicide for use in the control of aquatic weeds. Fluridone is sold under the trade name Sonar®, available from SePRO Corporation, Carmel, Ind., in either liquid or granulated formulations. Fluridone is a systemic herbicide that is absorbed from water by plant shoots and from hydrosoil by roots. It inhibits carotenoid synthesis which in turn enhances the degradation of chlorophyll. This produces a characteristic bleached appearance to susceptible plants. Fluridone is useful in the complete or partial control of many noxious plants. For example, fluridone is useful in the complete control of the floating plant common duckweed (Lemna minor), of the emersed plants spatterdock (Nuphar luteum) and water-lily (Nymphaea spp.), of the submersed plants bladderwart (Utricularia spp.), common coontail (Ceratophyllum demersum), common elodea (Elodea canadensis), eferia, Brazilian elodea (Egeria densa) fanwort, cabomba (Cabomba caroliniana), hydrilla (Hydrilla verticillata), naiad (Najas spp.), pondweed (Potamogeton spp.) other than Illinois pondweed, and watermilfoil (Myriophyllum spp.) other than variable-leaf milfoil), and of the shoreline grass paragrass (Urochloa mutica). Fluridone is useful in the partial control of the floating plants common watermeal (Wolffia columbiana) and salvinia (Salvinia spp.), the emersed plants alligatorweed (Alternanthera philoxeroides), American lotus (Nelumbo lutea), cattail (Typha spp.), creeping waterprimrose (Ludwigia peploides), parrotfeather (Myriophyllum aquaticum) smartweed (Polygonaum spp.), spikerush (Eleocharis spp.), waterpursiane (Ludwigia palustris), and watershield (Brasenia schreberi), of the submersed plants Illinois pondweed (Potamogeton illinoensis), limnophila (Limnophila sessiliflora), tapegrass or American eelgrass (Vallisneria americana), and watermilfoil-variable-leaf-milfoil (Myriophyllum heterophyllum), and the shoreline grasses barnyardgrass (Echinochloa crusgalli), giant cutgrass (Zizaniopsis miliacea), reed canarygrass (Philaris arundinaceae), southern watergrass (Hydrochloa caroliniensis) and torpedograss (Panicum repens). There are significant inter-species variations in susceptibility to fluridone, with some species usually susceptible to concentrations as low as about 5 ppb, and others usually susceptible to only higher concentrations such as 150 ppb.

In accordance with preferred methods of the invention, fluridone may be added to the body of water in either liquid or granular (including pelleted) formulations. Fluridone is a slow-acting herbicide which must remain in contact with the plant for several weeks to achieve effective control of most aquatic weeds. Thus, in accordance with the preferred methods of the invention, fluridone levels will be maintained in the body of water under treatment for at least about 4 weeks, and typically in the range of about 6 to about 16 weeks or more. For typical applications, the fluridone levels to be maintained will be in the range of about 1 ppb to about 150 ppb more typically in the range of about 5 ppb to about 50 ppb in the body of water under treatment.

Bodies of water to be treated with the inventive methods will typically be freshwater ponds, lakes, reservoirs, rivers or irrigation canals, although other bodies of water may also be treated.

As disclosed above, fluridone treatments of the invention are integrated with assays to determine the efficacy of fluridone on the local plant population in the body of water under treatment, and desirably also with assays to determine the concentration of fluridone existing during the treatment program. For example, in the present invention, an aquatic weed bioassay can be used to determine the pre-treatment susceptibility of a target plant population to fluridone. Such an assay may for instance involve the collection of meristematic stem tissue or vegetative propagules at selected sites within a body of water to be treated. The sites of collection may be logged, for instance using coordinates defined by the global positioning satellite (GPS) system. The samples may then be transported to a separate site such as a laboratory for processing.

Plant samples can be prepared for testing by cutting apical meristems to a known length and thoroughly washing the cut samples with deionized water to remove epiphytes and algae. A suitable, defined growth medium such as Hoaglands or Andrews growth medium is prepared and autoclaved. A known volume of such medium is poured into a series of Erlenmeyer flasks and these flasks are treated with selected, varying concentrations of fluridone. Plant samples can then be placed in the replicated treatment flasks. In this regard, the number of treatments and replicates utilized in a specific situation will usually be defined by the size of the water body to be treated, and the required resolution of the testing.

The plant samples are then placed in a growth chamber prior to further analysis, for example for a period of 4 or more days, usually example 4 to 14 days. The growth period utilizes defined growth conditions including defined temperature, photoperiod, and light intensities. Illustrative temperatures are in the range of about 15° to about 30° C., typically 25° C. Illustrative photoperiods will range from about 12 hours light:12 hours dark to about 16 hours light:8 hours dark. Typical light intensities will be about 300 to about 500 mmoles/m²/sec.

At the completion of the growth period, all new growth from the plants can be excised from the original plant tissue. This new tissue growth can be separated into multiple (e.g. 2) aliquots and weighed prior to biochemical analysis. Pigments from the plants, for example β-carotene, chlorophyll, and the terpene compound phytoene, are then assayed. This assay may involve the extraction of such pigments by standard methods, for example by extraction utilizing suitable solvents such as ketones (e.g. acetone), alcohols (e.g. methanol), or other polar solvents such as dimethylsulfoxide (DMSO). In this regard, the plant samples may optionally be ground before extraction to increase the release of chlorophyll and/or other pigments. After the extraction, the extracted sample is assayed to quantitate the levels of pigments, for example chlorophyll and/or β-carotene. Phytoene concentrations may also be assayed to provide a measure of the effect of the fluridone on the plant samples. This determination can be made using spectrophotometry, fluorometry, or other suitable methods. For example, spectrophotometric absorbance measurements for chlorophyll may be taken at 645 and/or 662 nm; for β-carotene may be taken at 445 nm; and for phytoene may be taken at 287 and/or 347 nm. These measured values may be compared to control data (e.g. including curves generated using samples of known concentration) to determine the level of these substances in the samples.

The measured values of the pigment(s) and/or other substances can then be used in a determination of the phytotoxic threshold of fluridone based upon the results of the current study and optionally also historical data of susceptible and tolerant plant populations of the species under study. This information on phytotoxic threshold can then be used in determining the amount and level of fluridone required to provide target plant efficacy.

Preferred methods of the present invention also involve plant biochemical testing conducted during the treatment. Thus, during the period in which a fluridone level is being maintained in the body of water under treatment, aquatic weed samples are obtained from the water body. This may involve, for example, collection of growing apical meristems from selected sites in the water body, preferably along with matched water samples from the same sites. Again, the sample sites can be logged using GPS or another suitable system to assist in future sampling and reference.

The aquatic weed plant samples can then be assessed to determine the effect of the maintained level of fluridone on the plants. To this end, the samples are first thoroughly washed and weighed. In a typical treatment, 6 to 12 samples per site will be collected. Similar to the discussions above, standard methods are then used to assay the level of pigments such as B-carotene, chlorophyll, and/or other relevant substances such as phytoene, in the tissue. These again may involve the extraction of such substances. The levels can be measured as discussed above using any suitable method such as spectrophotometry or fluorometry and appropriate standard curves. The measured values can then be utilized to determine whether any additional applications of fluridone or other adjustments are necessary to bring concentrations to levels that will be phytotoxic to the local aquatic weed population.

The biochemical assays discussed above, taken during treatment, are preferably used in conjunction with assays of water samples simultaneously taken, to determine the concentration of fluridone in the water body. Determination of the concentration of fluridone can be made in any suitable manner. Preferably, such a determination is made using an immunoassay. For example, a suitable immunoassay for fluridone known as the fastTEST™ is available from SePRO Corporation, Carmel, Ind., and can be used in present invention. The combination of measured fluridone concentration along with measured effect on plant health provides a particularly powerful method for the management of aquatic weeds in water bodies.

The fluridone concentration assays and plant bioassays may be taken one or more times during the treatment. For example, these assessments may be made every one to four weeks during the treatment period. In this manner, precise control of the aquatic weeds can be achieved even in situations where local populations of the same plant species exhibit widely varying susceptibility or tolerance to fluridone.

As in many aquatic weed management programs, integrated methods of the invention can be combined with other strategies to achieve long term control of aquatic weeds in the body of water. For example, fluridone may be rotated, alternated or used in combination with other chemical herbicidal agents in a long term control program, or may be used with or alternatively to other control methods including physical, mechanical, or biological controls. As well, other conventional management aids such as aerial photography, satellite imagery, bathymetry mapping and water flow analysis can be utilized in achieving optimal control of the aquatic weeds.

For the purpose of providing a further understanding of the present inventions and its principles of operation and advantages, the following specific examples are provided. It will be understood that these examples are illustrative and not limiting of the present invention.

### EXAMPLE 1

This example describes the treatment of a 2500-acre fresh water lake in Florida. The lake is a multi-use resource that has a history of infestation with hydrilla. A prior large-scale fluridone application had failed to provide hydrilla control. Hydrilla apical tips were sampled in several sites throughout the lake. The plant tissue samples were processed and placed in a defined growth medium (what medium? ______) in Erlenmeyer flasks at concentrations of 0, 3, 6, 12 and 24 ppb fluridone. Treatment flasks were placed in a growth chamber and the hydrilla samples were given a 12-day growth period at ambient temperature (about 25° C.) and under the natural photoperiod. On day 12, plant material was collected and chlorophyll, beta-carotene, and phytoene were extracted from new growth by ______ (describe extraction procedure). Pigment concentrations were compared amongst the various concentrations of fluridone and it was determined that threshold concentrations were achieved at 6 ppb (i.e. performance was not enhanced at increased concentrations of 12 and 24 ppb). Results indicated that these plants were susceptible to low target concentrations. These results were used to determine an appropriate treatment protocol for the entire lake.

### EXAMPLE 2

This Example describes the treatment of a ______ acre lake located in Florida to control hydrilla. Prior fluridone treatments had provided poor performance. Hydrilla apical tip samples were collected as in Example 1. The tissue samples were processed as described in Example 1 and exposed to fluridone concentrations of 0, 6, 12, 18 and 24 ppb. Flasks were placed in a growth chamber and plants were given a 13-day period of growth. On day 13, the hydrilla plant material was collected and phytoene, chlorophyll and β-carotene were extracted from new growth. Concentrations of these substances were again compared amongst the various concentrations of fluridone, and it was determined that threshold concentrations were not achieved until fluridone reached levels of 18 to 24 ppb. Based on water residue analysis from the previous years treatment, failure to obtain plant control was likely due to the fact that fluridone concentrations were well below 15 ppb for the bulk of the treatment time. Again, this information was used to achieve target plant control, and as well improved resource allocation planning.

### EXAMPLE 3

Wolverine Lake is a 220-acre water body located in east central Michigan. This lake has substantial shoreline development and has had an historic infestation with Eurasian watermilfoil. Two previous fluridone applications at rates of 5 and 6 ppb in the last 3 years have provided unsatisfactory results. Based on the history of poor control, plants were sampled from the lake and assayed as described above. Plants were exposed to concentrations of 0, 3, 6, 9, 12 and 15 ppb. Results from the assay indicated that although thresholds were achieved at 6 and 9 ppb, rapid recovery of the plants was noted at 3 ppb. These results were in contrast to the much lower thresholds noted for Eurasian watermilfoil sampled from other lakes in Michigan. Assay results from Wolverine Lake indicate that previous failures were likely due to residues dropping below the 6 ppb threshold prior to achieving control. Data were presented to the State DEQ and a rate of 12 ppb was permitted in the Fall of 2000 with the option of maintaining rates of above 6 ppb until control is achieved.

### EXAMPLE 4

Biochemical Assay and Immunoassay

Once a treatment is applied, the ability to monitor both the aqueous residues of fluridone as well as the response of the target (and non-target) plants to this concentration can provide valuable information. Due to the slow activity of fluridone, treatment failures are often not obvious until late in the treatment regime. Plant biochemical information can be used to provide a quantitative description of plant health at any point in the treatment cycle. In many cases, the addition of a small amount of product late in the treatment protocol could provide significantly improved control by maintaining threshold concentrations for a longer period of time. Likewise, the plant information can also be used to tell lake managers that additional applications are not necessary (i.e. the plant is responding normally to threshold doses).

### EXAMPLE 4

Spring Creek

The Spring Creek Arm of Lake Seminole (5000 acres) was treated in May 2000 using a drip system that added fluridone based on flow rates in the river. Both water and plants were sampled over time to determine the response of the hydrilla to various concentrations of fluridone that were found downstream of the initial injection site. As suggested by the pretreatment assay, hydrilla in this system as susceptible to rates as low as 5 ppb; however, plant sampling also indicated the lack of impact at several downstream sites. Plant response to the treatment was monitored and threshold water concentrations were determined. Based on the plant biochemical response, the injection system was altered to provide improved product distribution. Moreover, the system was run an additional 45 days over the planned 60 day treatment period to insure effective control was achieved.

### EXAMPLE 5

Lake Eva

Lake Eva in Central Florida was treated with fluridone in April 2000 at a target rate of 15 ppb. Personnel from Polk County Environmental Services (PCES) became concerned with the initial response of the plants to the treatment. Per the request of SePRO, plants were sent to our lab in Indiana and assayed for pigment concentration. Based on this assay, PCES was informed that current lake concentrations were below thresholds required to provide control. Additional product was added and plants and water were sampled throughout the summer to insure that target thresholds were maintained. This approach allowed the most judicious use of chemical to provide control. The results of the 2000 treatment were in stark contrast to the 1999 treatment, in which there was very poor control and very vocal dissatisfaction of local residents and County Commissioners.

### EXAMPLE 6

Lake McKinney

Lake McKinney, located in North Central Minnesota was treated with fluridone in the late summer of 1999 to control a substantial Eurasian watermilfoil population. Minnesota DNR personnel expressed concerns that Eurasian watermilfoil was going to recover the following spring. Both plant and water residue samples were collected in May and sent to the lab for processing. Results indicated that although residues in the lake were quite low, they remained above the threshold concentration required to control the remaining Eurasian watermilfoil. Therefore, no additional treatments were recommended. By the end of the summer, the target plant could no longer be found in the lake. In this case, plant and water information was used to recommend that no further actions be taken as it was likely that control would be achieved.

Combining Pretreatment Assays and Post-Treatment Biochemical/Immunoassay Monitoring:

In several situations, pretreatment assays were conducted to determine initial susceptibility of local populations and then following treatment biochemical and immunoassay monitoring were conducted to insure the progress of the treatment. Combining these technologies provides a powerful tool to conduct pretreatment planning as well as to allow for adjustments during the progress of the treatment. This approach to aquatic plant management provides a unique method for combining technologies to insure treatment success.

While the invention has been described in detail above with reference to specific embodiments, it will be understood that modifications and alterations in the embodiments disclosed may be made by those practiced in the art without departing from the spirit and scope of the invention. All such modifications and alterations are intended to be covered. In addition, all publications cited herein are indicative of the level of skill in the art and are hereby incorporated by reference in their entirety as if each had been individually incorporated by reference and fully set forth.

What is claimed is:

1. An integrated method for the control of aquatic weeds in a body of water, comprising:
(1) maintaining fluridone in a body of water having aquatic weeds;
(2) assessing water samples from the body of water to determine the level of fluridone in the water;
(3) assessing aquatic weed samples from the body of water to determine the effect of the fluridone on the weeds; and
(4) determining from steps (2) and (3) whether to adjust the level of fluridone in the body of water.

2. The method of claim 1, also comprising:
prior to said maintaining, assessing aquatic weed samples from the body of water to determine the susceptibility of the weeds to fluridone.

3. The method of claim 1, wherein said assessing aquatic weed samples includes assessing the level of one or more pigments in new growth of the weed samples.

4. The method of claim 3, wherein said one or more pigments is selected from β-carotene and chlorophyll.

5. The method of claim 4, wherein said periodically assessing aquatic weed samples includes assessing the level of each of β-carotene and chlorophyll in new growth of the weed samples.

6. The method of claim 5, wherein the β-carotene and chlorophyll are extracted from the weed samples for said assessing.

7. The method of claim 6, wherein the body of water contains freshwater.

8. The method of claim 7, wherein the body of water is a lake or pond.

9. The method of claim 7, wherein the aquatic weeds include one or more plants selected from the group consisting of watermeal (Wolffia columbiana), salvinia (Salvinia spp.), alligatorweed (Alternanthera philoxeroides), American lotus (Nelumbo lutea), cattail (Typha spp.), creeping waterprimrose (Ludwigia peploides) parrotfeather (Myriophyllum aquaticum), smartweed (Polygonaum spp.), spikerush (Eleocharis spp.), waterpursiane (Ludwigia palustris), watershield (Brasenia schreberi), Illinois pondweed (Potamogeton illinoensis), limnophila (Limnophila sessiliflora), tapegrass or American eelgrass (Vallisneria americana), watermilfoil (Myriophyllum heterophyllum), as barnyardgrass (Echinochloa crusgalli), giant cutgrass (Zizaniopsis miliacea), reed canarygrass (Philaris arundinaceae), southern watergrass (Hydrochloa caroliniensis) and torpedograss (Panicum repens).

10. The method of claim 9, wherein said periodically assessing water samples includes assessing the level of fluridone in the water samples using an immunoassay.

11. The method of claim 1, wherein said aquatic weed samples and water samples include matched water and weed samples taken simultaneously from the same location.

12. The method of claim 11, wherein said maintaining includes maintaining fluridone in said body of water at a level of about 1 to about 150 ppb.

13. The method of claim 12, which comprises maintaining fluridone in said body of water for a treatment period of at least about four weeks.

14. The method of claim 13, wherein said treatment period is about four weeks to about sixteen weeks.

15. A method for controlling aquatic weeds in a body of water with fluridone, comprising:
providing an assessed level of fluridone in water samples from the body of water;
providing an assessed effect of said level of fluridone on aquatic weed samples from the body of water; and
determining from said assessed level and said assessed effect whether to adjust the level of fluridone in the body of water.

16. The method of claim 15, wherein said assessed effect comprises an assessed level of one or more pigments in new growth of the weed samples.

17. The method of claim 16, wherein said assessed effect comprises assessed levels of β-carotene and chlorophyll in new growth of the weed samples.

18. The method of claim 17, wherein the body of water contains freshwater.

19. The method of claim 17, wherein the body of water is a lake or pond.

20. The method of claim 18, wherein the aquatic weeds include one or more plants selected from the group consisting of watermeal (Wolffia columbiana), salvinia (Salvinia spp.), alligatorweed (Alternanthera philoxeroides), American lotus (Nelumbo lutea), cattail (Typha spp.), creeping waterprimrose (Ludwigia peploides), parrotfeather (Myriophyllum aquaticum), smartweed (Polygonaum spp.), spikerush (Eleocharis spp.), waterpursiane (Ludwigia palustris), watershield (Brasenia schreberi), Illinois pondweed (Potamogeton illinoensis), limnophila (Limnophila sessiliflora), tapegrass or American eelgrass (Vallisneria americana), watermilfoil (Myriophyllum heterophyllum), as barnyardgrass (Echinochloa crusgalli), giant cutgrass (Zizaniopsis miliacea), reed canarygrass (Philaris arundinaceae), southern watergrass (Hydrochloa caroliniensis) and torpedograss (Panicum repens).

21. The method of claim 20, wherein said assessed level of fluridone has been obtained using an immunoassay.

22. The method of claim 21, wherein said aquatic weed samples and water samples include matched water and weed samples taken simultaneously from the same location.

23. The method of claim 20, wherein said assessed level of fluridone is about 1 to about 150 ppb.

24. A method for assessing the effect of fluridone on an aquatic weed, comprising:
providing an aquatic weed sample taken from a body of water containing a treatment level of fluridone; and
assessing the effect of the fluridone on the weed sample.

25. The method of claim 24, wherein said assessing includes assessing the level of one or more pigments in new growth of the sample.

26. The method of claim 25, wherein said assessing includes assessing the level of chlorophyll in new growth of the sample.

27. The method of claim 26, wherein said assessing also includes assessing the level of β-carotene in new growth of the sample.

28. The method of claim 26, wherein the aquatic weed is selected from the group consisting of watermeal (Wolffia columbiana), salvinia (Salvinia spp.), alligatorweed (Alternanthera philoxeroides), American lotus (Nelumbo lutea), cattail (Typha spp.), creeping waterprimrose (Ludwigia peploides), parrotfeather (Myriophyllum aquaticum), smartweed (Polygonaum spp.), spikerush (Eleocharis spp.), waterpursiane (Ludwigia palustris), watershield (Brasenia schreberi), Illinois pondweed (Potamogeton illinoensis), limnophila (Limnophila sessiliflora), tapegrass or American eelgrass (Vallisneria americana), watermilfoil (Myriophyllum heterophyllum), as barnyardgrass (Echinochloa crusgalli), giant cutgrass (Zizaniopsis miliacea), reed canarygrass (Philaris arundinaceae), southern watergrass (Hydrochloa caroliniensis) and torpedograss (Panicum repens).

29. The method of claim 28, wherein the aquatic weed is hydrilla.

30. The method of claim 28, wherein the treatment level of fluridone is about 1 to about 150 ppb.

31. The method of claim 30, wherein said assessing includes assessing the level of chlorophyll in new growth of the sample by preparing an extract containing chlorophyll from the sample and measuring the level of chlorophyll in the extract.

32. The method of claim 31, wherein said measuring comprises a spectrophotometric analysis of the extract.

33. The method of claim 31 wherein said extract also contains β-carotene and phytoene, and said measuring includes measuring the level of β-carotene and phytoene in the extract.

34. A method for assessing the fluridone susceptibility of a local population of aquatic weeds in a body of water to be treated with fluridone, comprising:
providing a plurality of aquatic weed samples taken from the body of water to be treated with fluridone;
assessing the effect of varying levels of fluridone on the weed samples; and
determining the susceptability of the aquatic weeds to fluridone based upon said assessing.

35. The method of claim 34, wherein said aquatic weed samples are tissue samples effective to initiate new growth.

36. The method of claim 35, wherein said assessing comprises incubating said tissue samples in a growth medium for a growth period, isolating new tissue grown during the growth period, and assessing the new tissue.

37. The method of claim 36, wherein said tissue samples comprise apical meristems.

38. The method of claim 36, wherein said assessing the new tissue comprises preparing an extract of the tissue, and analyzing the extract.

39. A method for assessing the effect of a chemical agent on an aquatic weed, comprising:
obtaining a tissue sample from the aquatic weed, said tissue sample effective to initiate new growth;
incubating the tissue sample in a growth medium effective to cause new tissue growth from the sample;
contacting the tissue sample with the chemical agent during said incubating; and
assessing the sample after said incubating.

40. The method of claim 39, wherein said chemical agent is a herbicidal agent.

41. The method of claim 40, wherein said herbicidal agent is a bleaching herbicidal agent.

42. The method of claim 41, wherein said herbicidal agent is fluridone.

43. The method of claim 39, wherein said assessing comprises isolating said new tissue growth, preparing an extract of said new tissue growth, and assaying the extract.

44. A method for assessing the susceptibility of a local aquatic weed population to a chemical agent, comprising:
obtaining a plurality of aquatic weed tissue samples from aquatic weeds from a body of water, said aquatic weed tissue samples effective to initiate new tissue growth;
incubating said aquatic weed tissue samples in a growth medium effective to support new tissue growth;
contacting said aquatic weed tissue samples with varying levels of said chemical agent during said incubating;
wherein new tissue growth from said samples after said incubating and contacting can be assessed to determine a susceptibility of the aquatic weed population to the chemical agent.

45. The method of claim 44, wherein said chemical agent is fluridone.

46. An integrated method for managing an aquatic weed population in a body of water by treatment with a herbicidal agent, comprising:
(a) prior to treating the body of water with the herbicidal agent, determining the susceptibility of the weed population to the herbicidal agent, said determining comprising:
(1) obtaining a plurality of aquatic weed tissue samples from aquatic weeds from a body of water, said aquatic weed tissue samples effective to initiate new tissue growth;
(2) incubating said aquatic weed tissue samples in a growth medium effective to support new tissue growth;
(3) contacting said aquatic weed tissue samples with varying levels of the chemical agent during said incubating; wherein new tissue growth from said samples after said incubating and contacting can be assessed to determine a susceptibility of the aquatic weed population to said chemical agent;
(b) treating said body of water with the chemical agent at a selected level based upon the susceptibility of the aquatic weed population determined in step (a);
(c) during said treating of step (b), assessing the effect of said level of herbicidal agent on the aquatic weed population, said assessing comprising:
(1) obtaining a plurality of aquatic weed tissue samples from aquatic weeds from the herbicidal agent-treated body of water, said aquatic weed tissue samples having new tissue growth formed during said treating;
(2) assessing the new tissue growth to determine the effect of said level of herbicidal agent on said weed population; and
(d) continuing treatment of the body of water with said herbicidal agent at a level based upon said assessing of step (c).

47. The method of claim 46, wherein said herbicidal agent is a bleaching herbicidal agent.

48. The method of claim 47, wherein said herbicidal agent is fluridone.
